(19) United States
(12) Patent Application Publication
(10) Pub. No.: US 2024/0429411 A1
(43) Pub. Date: Dec. 26, 2024

(54) FUEL CELL SYSTEM

(71) Applicant: AVL List GmbH, Graz (AT)

(72) Inventor: Raphael NEUBAUER, Graz (AT)

(73) Assignee: AVL List GmbH, Graz (AT)

(21) Appl. No.: 18/710,202

(22) PCT Filed: Nov. 14, 2022
(86) PCT No.: PCT/AT2022/060395

§ 371 Date: May 15, 2024

(30) Foreign Application Priority Data
Nov. 15, 2021 (AT) A 50911/2021

(51) Int. Cl. H01M 8/04089; H01M 8/04007; H01M 8/04082; H01M 8/04111; H01M 8/12

(52) U.S. Cl. CPC H01M 8/04097; H01M 8/04067; H01M 8/04111; H01M 8/04201; H01M 8/12; H01M 2008/1293

(57) ABSTRACT

The invention relates to a fuel cell system (1), in particular an SOFC system, comprising at least one fuel cell stack (2) with an anode section (3) and a cathode section (4), an air supply section (5), a fuel supply section (6) and a recirculation section (7), wherein a heat exchanger network with at least one first heat exchanger (8) and a second heat exchanger (9) is provided, wherein the second heat exchanger (9) is arranged downstream of the first heat exchanger (8), wherein a cold side of the first heat exchanger (8) is arranged in the fuel supply section (6) and a cold side of the second heat exchanger (9) is arranged in the air supply section (7).

The invention further relates to the use of such a fuel cell system (1).

The invention relates to a fuel cell system, in particular an SOFC system, comprising at least one fuel cell stack with an anode section and a cathode section, an air supply section, a fuel supply section and a recirculation section, wherein a heat exchanger network is provided with at least one first heat exchanger and a second heat exchanger, wherein the second heat exchanger is arranged downstream of the first heat exchanger.

The invention further relates to the use of such a fuel cell system.

SOFC systems are known from the prior art. In order to increase the efficiency of an SOFC system, it is known for hot anode exhaust gas to be recirculated and thus also increase the fuel utilisation of the system. This recirculation can for example be implemented with hot gas blowers. However, the technical implementation and also the service life of the hot gas blower are problematic, because anode exhaust gas in a high-temperature fuel cell system, in particular an SOFC system, has a temperature of between 500° C. and 1000° C. In addition, many fuel cell systems require a shielding gas to protect the fuel cell stack, in particular the fuel electrode, from degradation during the heating-up process. It may be necessary to introduce heat into the system, which is not trivial, since there are very different temperature requirements in the fuel cell system.

This is the starting point for the invention. The object of the invention is to provide a fuel cell system which can be operated particularly efficiently, in which a blower can in particular be operated in a recirculation section without any problems.

A further object relates to a use of such a fuel cell system.

According to the invention, this object is achieved in that, in a fuel cell system of the type described above, a cold side of the first heat exchanger is arranged in the fuel supply section and a cold side of the second heat exchanger is arranged in the air supply section.

One advantage achieved in this way is, in particular, that, due to the special arrangement of the heat exchanger network, so much heat is extracted from the anode exhaust gas that the temperature of the anode exhaust gas which is to be recirculated remains at least above a condensate temperature. Due to the arrangement of the at least two heat exchangers, the temperature in the recirculation section and/or in the fuel supply section can be controlled. The first heat exchanger is in particular designed as a fuel/fuel heat exchanger and the second heat exchanger is designed as an air/fuel heat exchanger.

The respective hot sides of the heat exchangers are advantageously part of the recirculation section and/or the fuel supply section. The hot side of the first heat exchanger is advantageously arranged in the recirculation section in all embodiments, whereas the hot side of the second heat exchanger is arranged either in the recirculation section or in the fuel supply section.

The fuel cell system is in particular designed as a high-temperature fuel cell system and preferably as an SOFC system.

The recirculation section serves to recirculate anode exhaust gas as a recirculation gas from the anode section of the fuel cell stack of the fuel cell system. For this purpose, the recirculation section is in particular equipped with a recirculation line, which is in particular connected to the anode section in a fluid-communicating manner. The recirculation section is integrated into the fuel cell system.

The hot side of the first heat exchanger is arranged in the recirculation section, with the cold side of the first heat exchanger being arranged in the fuel supply section.

In the fuel cell system according to the invention, an air supply section is provided via which air can be conveyed from an air source in the direction of the cathode section. In the context of the invention, air is to be understood as a gas containing oxygen. The fuel cell system also has a fuel supply section via which fuel can be conveyed from a fuel source in the direction of the anode section. A carbonaceous gas such as methane or ethane, natural gas or hydrogen can for example be used as fuel. In principle, a liquid fuel can also be used. Of course, the fuel cell system preferably includes other components, for example a reformer or a reformer heat exchanger which reforms fuel for conversion in the anode section, catalytists, for example in an exhaust line, for converting remaining fuel components in the exhaust gas, or further heat exchanger devices.

A dividing device is preferably provided downstream of the fuel cell stack which serves to divide the exhaust gas into the recirculation section and into an exhaust line. An oxidation catalyst is preferably provided in the exhaust line to convert remaining fuel components in the exhaust gas or for heat recovery, and a further heat exchanger designed as an air/air heat exchanger is provided to transfer heat to the air supply section. The other part is fed back into the fuel cell stack via the recirculation section in order to increase the fuel utilisation and thus the electrical efficiency of the fuel cell system.

Exhaust gas is routed via the recirculation section, being passed successively through the first and second heat exchanger, releasing heat to the fuel supply section via the first heat exchanger and heat to the air supply section via the second heat exchanger.

It is particularly advantageous if a blower is arranged in the recirculation section or in the fuel supply section, in particular downstream of the second heat exchanger. The blower is preferably designed as a recirculation blower and is arranged and designed to convey the exhaust gas in the recirculation section back in the direction of the fuel cell stack. The first heat exchanger is designed to reduce the temperature of the recirculated exhaust gas, so that the blower no longer needs to be designed as a hot gas blower. The first heat exchanger already removes a large part of the heat from the recirculated exhaust gas. The exhaust gas usually has a temperature in the range of 500° C. to 1000° C. at an outlet of the fuel cell stack. After the recirculation blower, the recirculated exhaust gas is brought back to temperature via the first heat exchanger and fed back into the fuel cell stack, in particular via a reformer.

According to the invention, fresh fuel is mixed with the recirculated exhaust gas and passed to the anode section downstream of a corresponding fluidic connection between the recirculated exhaust gas and the fuel in the fuel supply section. If the blower is arranged downstream of such a fluidic connection, it is nevertheless referred to advantageously as a recirculation blower in the context of the invention, since it is in particular designed and arranged to convey the exhaust gas which is to be recirculated.

It is also advantageous if a bypass line is provided in the air supply section via which the cold side of the second heat exchanger can be bypassed. The second heat exchanger is in particular designed and arranged as a fuel/air heat exchanger and cools the recirculated anode exhaust gas to a desired, predetermined temperature. A heat sink is thereby provided by the cool air. This has the advantage that the recirculated anode exhaust gas can be cooled down to the condensation temperature and the heat absorbed by the air is fed back into the system via the air supply line. As a result, the efficiency requirements for the first heat exchanger are relaxed by the second heat exchanger, which means that the first heat exchanger can be made smaller and less costly. In order to be able to control the temperature of the anode exhaust gas in the recirculation section (i.e. the recirculated anode exhaust gas), the bypass line is provided in the air supply section. In this case the division between the bypass line and the second heat exchanger is adjusted by means of suitable actuators in the air supply section, as a result of which the temperature in the recirculation section can be controlled.

The arrangement of the two heat exchangers in combination with the bypass line brings the advantage that the temperature at an inlet of the blower can always be adjusted between a maximum value and a minimum value, even under different operating conditions. A temperature of between 80° C. and 250° C. has for example been found to be a practical temperature.

It is advantageous if, in the fuel cell system according to the invention, fresh fuel can be introduced into the recirculation section, for which purpose the fuel supply section and the recirculation section are fluidically connected to each other. Preferably, the line or lines downstream of such a fluidic connection is referred to as the fuel supply section.

It is expedient if the fuel supply section includes a fuel line, whereby fuel can be fed into the recirculation section via the fuel line upstream of the first heat exchanger. In other words, fresh fuel is introduced into the recirculation section via a fluidic connection between the fuel supply section and the recirculation section.

Downstream of this connection, a corresponding section is also advantageously referred to as the fuel supply section. In this design variant, the fuel is fed into the recirculation section upstream of the second heat exchanger and downstream of the first heat exchanger, whereby these two fluids are then preferably conveyed further in the fuel supply section. This arrangement allows the fuel to be sucked in by the blower if its supply pressure is too low, whereby a valve and mass flow measurement can for example be provided for regulation. Furthermore, the introduction of fuel upstream of the second heat exchanger (at this point the temperature of the exhaust gas in the recirculation section is still around 200° C.) reduces the risk of local condensation, as the exhaust gas in the recirculation section is still hot enough to heat up the fresh fuel without falling below a condensation temperature as a result. The condensation temperature of the exhaust gas in the recirculation section is around 80° C., but this depends on the recirculation rate and fuel utilisation at the fuel cell stack. In this embodiment, the second heat exchanger is arranged with its hot side in the fuel supply section and with its cold side in the air supply section.

Alternatively, it can be advantageous if the fuel supply section includes a fuel line, wherein fuel can be fed to the recirculation section via the fuel line between the second heat exchanger and the blower. In this case, fresh fuel is introduced into the recirculation section via a fluidic connection between the fuel supply section and the recirculation section downstream of the second heat exchanger and upstream of the blower. Downstream of this connection, a corresponding section is also advantageously referred to as the fuel supply section. This arrangement is in particular advantageous if the supply pressure of the fresh fuel is low and no local condensation occurs. In this embodiment, the second heat exchanger is arranged with its hot side in the recirculation section and with its cold side in the air supply section.

In a further design variant of the invention, it is advantageous if the fuel supply section includes a fuel line, whereby fuel can be fed into the recirculation section via the fuel line between the blower and the first heat exchanger. In this case, fresh fuel is introduced into the recirculation section via a fluidic connection between the fuel supply section and the recirculation section downstream of the blower and upstream of the first heat exchanger. Downstream of this connection, a corresponding section is advantageously also referred to as the fuel supply section. This is in particular advantageous if a fuel supply pressure is high enough to be introduced via a mass flow controller (MFC) for example. Since the anode exhaust gas is heated again by compression in the blower, the risk of local condensation is reduced again depending on the temperature level. In this embodiment, the second heat exchanger is arranged with its hot side in the recirculation section and with its cold side in the air supply section.

It is advantageous if a cathode discharge line and an anode discharge line is provided. Preferably, these are designed separately from each other, so that no common exhaust line from the fuel cell stack is provided. The anode discharge line is divided into the recirculation section and an exhaust line by a dividing device downstream of the fuel cell stack, with exhaust gas being discharged into the environment via the exhaust line, in which at least one oxidation catalyst is arranged.

It is advantageous if an oxidation catalyst is arranged downstream of the fuel cell stack, whereby part of an exhaust gas can be fed to the oxidation catalyst. Particularly preferably, both anode exhaust gas and cathode exhaust gas can be fed to the oxidation catalyst, in particular via two separate lines. A further heat exchanger is preferably arranged downstream of the oxidation catalyst, via which any remaining heat from the exhaust gas is transferred to the air which is conveyed to the cathode section. The cold side of this heat exchanger is thus arranged in the air supply section.

It is expedient if a reformer heat exchanger is provided, whereby a hot side of the reformer heat exchanger is arranged in the cathode discharge line. This means that the reformer is brought to operating temperature by the hot cathode exhaust gas. Downstream of the reformer heat exchanger, the cathode exhaust gas is then fed to the oxidation catalyst, as has been described. The reformer heat exchanger thus comprises a cold side upstream of the anode section, which forms a reformer, and a hot side downstream of the cathode section, which forms a heat exchanger. It has transpired that, taking into account various factors, it is quite possible, and can also be advantageous, to feed the cathode exhaust gas completely to the heat exchanger on the reformer or the hot side of the reformer heat exchanger. In the first place, it is advantageous that there is no need for flow dividers downstream of the cathode section. Flow dividers lead to a complex system structure, for which correspondingly complex functional components are required. These are not only expensive, but are also reflected in the weight, which should always be reduced, in particular in mobile applications. In addition, the use of flow dividers means that complex control and regulation steps need to be implemented in the fuel cell system. These can be dispensed with if the cathode exhaust gas is directed from the cathode section directly and unbranched, i.e. completely, to the heat exchanger on the reformer.

It is advantageous if a starting burner is provided. The starting burner heats up the fuel cell system. The starting burner can for example advantageously be designed as a flame burner, as a catalytic burner or as a hybrid burner (catalytic combined with flame). It can also be advantageous if the starting burner is integrated into or combined with an oxidation catalyst. The heat released by the start burner can advantageously be introduced into the system at various points, for example into a cathode exhaust line directly downstream of the cathode section, into the air supply line or directly into the oxidation catalyst or downstream thereof. The arrangement of the starting burner depends on individual component specifications such as temperature limits, compatibility of combustion exhaust gas and the like.

It is advantageous if a reformer is provided for the production of shielding gas through catalytic partial oxidation. A reformer for the production of shielding gas by catalytic partial oxidation (CPOX reformer) has proved to be an effective means of producing a suitable shielding gas internally. In this process, air and fuel are catalytically converted into a synthesis gas. This reaction is a catalytic oxidation process which is exothermic and therefore self-sustaining. However, before the reaction, the catalyst must first be brought above the so-called light-off temperature. This is advantageously achieved by means of a heat source, whereby both heat from the fuel cell system (e.g. from the starting burner) as well as external, electrical or thermal energy such as heat energy can be used. Once the CPOX (catalytic partial oxidation) reaction has started, this additional energy is no longer required. The resulting shielding gas can advantageously be introduced before or after the reformer. Introduction upstream or downstream of the reformer has the following advantages: the shielding gas from the CPOX reformer is typically hotter than 600° C. In order to be able to comply with any temperature limitation, it is cooled in the reformer upstream of the fuel cell stack in order to protect the fuel cell stack from excessively high inlet temperatures. In addition, the shielding gas can also be used for the activation of for example Ni-based catalysts in the reformer. If neither temperature nor reformer activation are a problem, the shielding gas can also advantageously be introduced directly before the fuel cell stack.

In order to reduce the complexity and installation space of the fuel cell system as a whole, the CPOX reformer can, alternatively, also be integrated into the general reformer. This brings the following advantages: no additional fuel line and no additional reformer are required. In this case, the heating to above the light-off temperature takes place internally within the fuel cell system by means of the hot cathode exhaust gas itself, whereby the light-off temperature lies in the range between 250° C. and 500° C. As soon as the CPOX reaction has started, the exothermic CPOX reaction (>600° C.) begins, as a result of which the catalytic converter is actively cooled (in metal-based fuel cell stacks for example, the cathode exhaust gas temperature is usually below 600° C. during the heating process). The reformer catalyst should be designed for both CPOX reforming and steam reforming. This can preferably be achieved using a two-stage reformer (e.g. a precious metal catalyst followed by an Ni-based catalyst) or using a correspondingly robust single-stage catalyst.

A fuel cell system according to the invention can be used advantageously as a stationary system or in a motor vehicle. The fuel cell system according to the invention can also be used advantageously in marine applications or aircraft.

Further advantages, features and details of the invention are explained in the following description, in which exemplary embodiments of the invention are described in detail with reference to the drawing. In each case schematically:

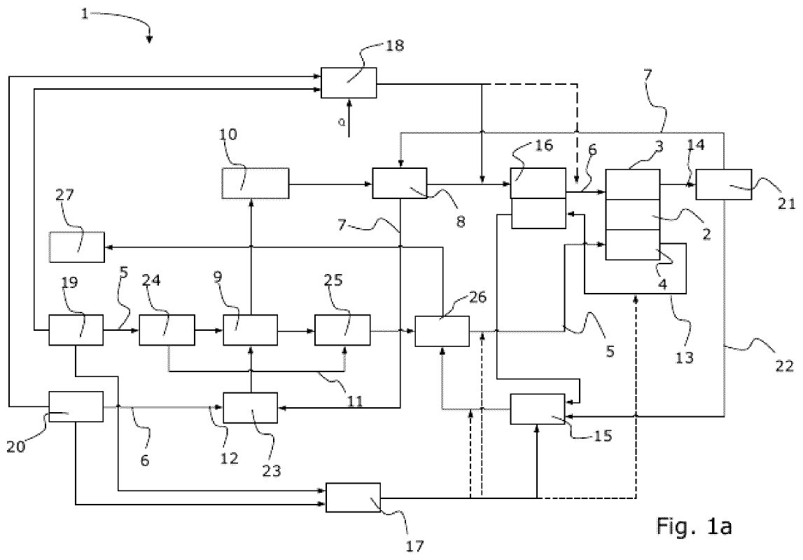

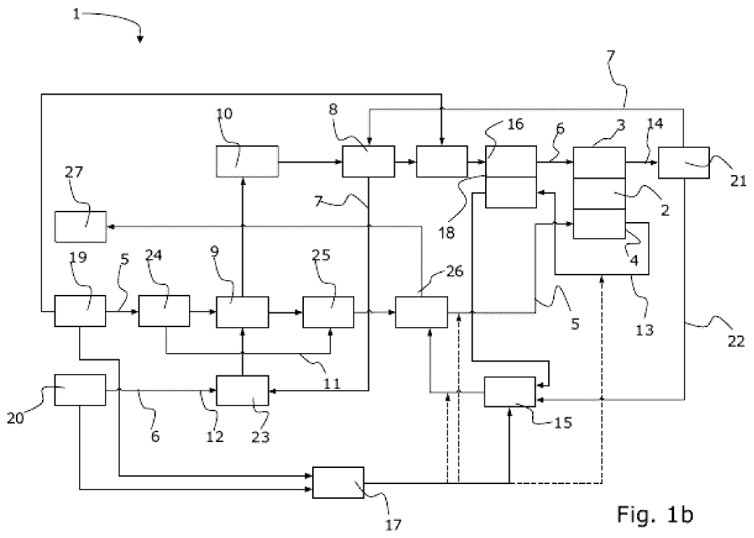

FIG. 1a shows a schematic representation of a fuel cell system according to the invention;

FIG. 1b shows a schematic representation of another fuel cell system according to the invention;

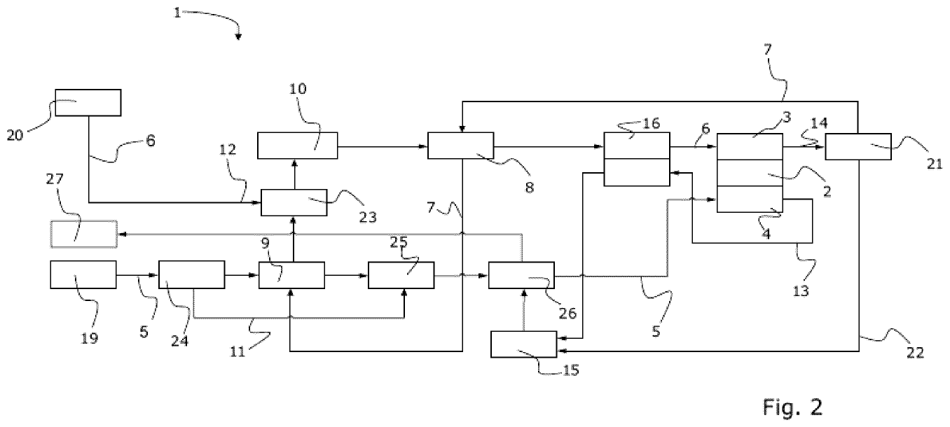

FIG. 2 shows a schematic representation of another fuel cell system according to the invention;

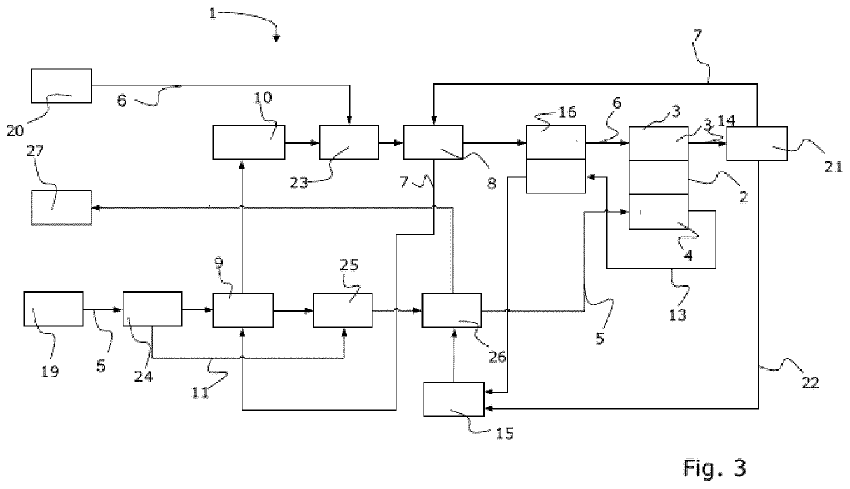

FIG. 3 shows a schematic representation of another fuel cell system according to the invention.

FIG. 1a shows a fuel cell system 1 according to the invention with a fuel cell stack 2 comprising an anode section 3 and a cathode section 4. An air source 19 is provided, to which an air supply section 5 is connected to convey air in the direction of the cathode section 4. A fuel source 20 is also provided, to which a fuel supply section 6 with a fuel line 12 is connected to convey fuel in the direction of the anode section 3. The fuel cell system 1 also includes a recirculation section 7, via which exhaust gas from the anode section 3 is conveyed back in the direction of the anode section 3 by a blower 10. Downstream of the fuel cell stack 2, a first dividing device 21 is provided by means of which the anode exhaust gas can be divided into the recirculation section 7 and into an exhaust line 22.

The part of the anode exhaust gas in recirculation section 7, i.e. the recirculated exhaust gas, is passed through a first heat exchanger 8 and a second heat exchanger 9. The first heat exchanger 8 is arranged upstream of the second heat exchanger 9, whereby a hot side of the first heat exchanger 8 is arranged in the recirculation section 7 and a cold side of the first heat exchanger 8 is arranged in the fuel supply section 6. Heat is thus extracted from the hot anode exhaust gas and the first heat exchanger 8 is designed as a fuel/fuel heat exchanger. The blower 10, which is designed as a recirculation blower, is arranged between the first heat exchanger 8 and the second heat exchanger 9 and is designed to convey the anode exhaust gas.

Upstream of the second heat exchanger 9, a fluidic connection 23 is provided between the recirculation section 7 and the fuel supply section 6, so that fresh fuel can be introduced into the recirculation section 7 via the fuel line 12. The fresh fuel, together with the recirculated exhaust gas, is now conveyed in the fuel supply section 6 in the direction of the anode section 3. In a first step, this fuel is passed through the cold side of the first heat exchanger 8, as a result of which this is heated up again.

A reformer heat exchanger 16 is arranged upstream of the anode section 3 and downstream of the cold side of the first heat exchanger 8 which prepares the fuel for use in the anode section 3. Cathode exhaust gas is supplied to the reformer heat exchanger 16 via the cathode discharge line 13 to heat up the corresponding reformer section.

The air supply section 5 has a bypass line 11 via which the second heat exchanger 9 can be bypassed. For this purpose, a branch 24 is provided upstream of the second heat exchanger 9 from which the bypass line 11 branches off, and a connection 25, where the bypass line 11 reconnects, is provided downstream of the second heat exchanger 9. A further heat exchanger 26 is provided downstream of the connection 25, with its cold side arranged in the air supply line and its hot side arranged in the exhaust line 22, so that the hot exhaust gas transfers heat to the air for use in the cathode section 4. The further heat exchanger 26 is thus designed and arranged as an air/air heat exchanger.

An oxidation catalyst 15 is arranged in the exhaust line 22, whereby both the exhaust line and the cathode discharge line 13 (downstream of the reformer heat exchanger 16) lead into this. In other words, anode exhaust gas is combusted with cathode exhaust gas being supplied. The combusted exhaust gas is then discharged to the environment 27 via the further heat exchanger 26.

The fuel cell system 1 according to FIG. 1a also includes a starting burner 17, which is supplied with both fuel from the fuel source 20 as well as air from the air source 19. The starting burner 17 is arranged and designed to heat up the fuel cell system 1. For this purpose, the heat is for example supplied directly to the oxidation catalyst 15 (solid line) or the exhaust line 22 downstream thereof, or to the air supply line 5 or the cathode exhaust line 13 (in each case represented by dashed lines).

In addition, a reformer 18 is provided for the production of shielding gas by catalytic partial oxidation (CPOX reformer). As shown in FIG. 1, both fuel and air are supplied to this as well. Since a certain light-off temperature is required to bring the CPOX reformer up to operating temperature, a heat supply Q to the reformer 18 is provided. The reformer 18 or the reaction that takes place therein produces a so-called shielding gas which can for example be fed in upstream or downstream of the reformer heat exchanger 16 in order to protect the fuel cell stack 2 in particular.

FIG. 1b shows another fuel cell system 1 according to the invention. Elements which have the same function and in particular the same arrangement as those shown in FIG. 1a also have the same reference signs and are not described further. In contrast to FIG. 1a, in the fuel cell system 1 according to FIG. 1b the reformer 18 for the production of shielding gas by catalytic partial oxidation is not designed and arranged as a separate element, but is integrated into the reformer part of the reformer heat exchanger 16. For this purpose, the reformer heat exchanger 16 is designed for both CPOX and also steam reforming.

FIG. 2 shows another fuel cell system 1 according to the invention. Here too, elements which have the same function and in particular the same arrangement as those shown in FIG. 1a or 1b have the same reference signs and are not described further. In contrast to the fuel cell systems 1 according to FIGS. 1a and 1b, in this case the fluidic connection 23 between the fuel supply section 12 and the recirculation section 7 is arranged downstream of the second heat exchanger 9 and upstream of the blower 10. For the sake of simplicity, FIG. 2 does not show the starting burner 17 and the CPOX reformer. Of course, the fuel cell system 1 as shown in FIG. 2 can also include these elements.

FIG. 3 shows another fuel cell system 1 according to the invention. Here, too, elements which have the same function and in particular the same arrangement as those shown in FIG. 1a, 1b or 2 have the same reference signs and are not described further. In contrast to the fuel cell systems 1 according to FIGS. 1a and 1b and 2, in this case the fluidic connection 23 between the fuel supply section 12 and the recirculation section 7 is arranged downstream of the blower 10 and upstream of the first heat exchanger 8. For the sake of simplicity, FIG. 3 also does not show the starting burner 17 and the CPOX reformer. Of course, the fuel cell system 1 as shown in FIG. 2 can also include these elements.

In summary, the fuel cell system according to the invention has the following advantages in particular:
High recirculation rates can be implemented with recirculation blowers and the temperature at the inlet of the recirculation blower can be controlled, even to a very low temperature level;
Heat extracted from the anode path remains in the system;
High efficiency requirements for the fuel/fuel heat exchanger (first heat exchanger 8) and the air/air heat exchanger (further heat exchanger 26) are relaxed;
The introduction of fresh fuel and implementation using the recirculation blower avoids upstream compression of the fresh fuel;
The risk of local condensation before the recirculation blower and associated damage to the recirculation blower is reduced.

1. Fuel cell system, in particular an SOFC system, comprising at least one fuel cell stack with an anode section and a cathode section, an air supply section, a fuel supply section and a recirculation section, wherein a heat exchanger network with at least one first heat exchanger and a second heat exchanger is provided, wherein the second heat exchanger is arranged downstream of the first heat exchanger, characterised in that a cold side of the first heat exchanger is arranged in the fuel supply section and a cold side of the second heat exchanger is arranged in the air supply section.

2. Fuel cell system according to claim 1, wherein a blower is arranged in the recirculation section or in a fuel supply section, in particular downstream of the second heat exchanger.

3. Fuel cell system according to claim 1, wherein a bypass line is provided in the air supply section via which the cold side of the second heat exchanger can be bypassed.

4. Fuel cell system according to claim 1, wherein the fuel supply section includes a fuel line, wherein fuel can be supplied to the recirculation section via the fuel line upstream of the second heat exchanger.

5. Fuel cell system according to claim 2, wherein the fuel supply section includes a fuel line, wherein fuel can be supplied to the recirculation section via the fuel line between the second heat exchanger and the blower.

6. Fuel cell system according to claim 2, wherein the fuel supply section includes a fuel line, wherein fuel can be supplied to the recirculation section via the fuel line between the blower and the first heat exchanger.

7. Fuel cell system according to claim 1, wherein a cathode discharge line and an anode discharge line is provided.

8. Fuel cell system according to claim 1, wherein an oxidation catalyst is arranged downstream of the fuel cell stack, wherein part of an exhaust gas can be fed to the oxidation catalyst.

9. Fuel cell system according to claim 7, wherein a reformer heat exchanger is provided, wherein a hot side of the reformer heat exchanger is arranged in the cathode discharge line.

10. Fuel cell system according to claim 1, wherein a starting burner is provided.

11. Fuel cell system according to claim 1, wherein a reformer is provided for the production of shield gas by catalytic partial oxidation.

12. A method of using a fuel cell system according to claim 1 as a stationary installation or in a motor vehicle.
